(19) United States
(12) Patent Application Publication
(10) Pub. No.: US 2006/0231543 A1
(43) Pub. Date: Oct. 19, 2006

(54) Heating apparatus

(75) Inventors: Akira Sasaki, Tokyo (JP); Yoshiyuki Motoyoshi, Tokyo (JP); Tsuyoshi Kobayashi, Tokyo (JP); Mitsushi Wadasako, Hamamatsu-shi (JP); Emico Taguchi, Ikoma-gun (JP)

Correspondence Address: NIXON & VANDERHYE, PC, 901 NORTH GLEBE ROAD, 11TH FLOOR, ARLINGTON, VA, 22203, US

(73) Assignees: Nichias Corporation, Tokyo (JP); Thermos Corporation, Nara-ken (JP)

(21) Appl. No.: 11/394,183

(22) Filed: Mar. 31, 2006

(30) Foreign Application Priority Data
Mar. 31, 2005 (JP) P. 2005-102741

(51) Int. Cl. H05B 11/00; H05B 1/00; H05B 3/00

(52) U.S. Cl. 219/216

(57) ABSTRACT

The present invention provides a heating apparatus including: a power source for heating; a heating element; and a bimetal-type thermostat placed between the power source and the heating element, the bimetal-type thermostat cutting off energization upon temperature reaching to a first temperature and restoring the energization upon temperature dropping and reaching to a second temperature, the bimetal-type thermostat having a resetting temperature of 0° C. or lower.

### FIELD OF THE INVENTION

The present invention relates to a heating apparatus, and particularly to a heating apparatus having a function to automatically prevent an excessive temperature rise.

### BACKGROUND OF THE INVENTION

For example, in a manufacturing apparatus of a semiconductor element, an FPD (Flat Panel Display) or the like, a mantle heater is conventionally frequently used in order to heat a pipe, a joint, a valve and the like up to a specified temperature and to keep it (see, for example, reference 1). FIG. 3 is a perspective view showing an example of a mantle heater, and a mantle heater 100 shown in the drawing is constructed such that a heating element 103 is sandwiched between an inner layer material 101 made of a flexible synthetic resin sheet and an-outer layer material 102. Electric power is applied to the heating element 103 in a state where it covers a pipe 104 as an object to be heated, so that the pipe 104 is heated.

In order to prevent an excessive temperature rise, the mantle heater 100 as stated above is constructed such that for example, as shown in FIG. 4, a temperature fuse 112 is placed between a power source 110 and a heater element 111, and when the temperature fuse 112 is heated to a melting temperature or higher, the energization to the heater element 111 is cut off.

Besides, there is also known a structure in which as shown in FIG. 5. a thermostat 121 is disposed in the vicinity of a heater element 111, the temperature of the heater element 111 is always monitored, and when the temperature reaches a specified temperature, the energization to the heater element 111 is cut off based on a signal from the thermostat 111. Further, there is also known a structure in which as shown in FIG. 6, a thermocouple 131 is used instead of the thermostat 121.

Besides, there is also known a structure in which in the excessive temperature rise prevention mechanism shown in FIG. 4, a bimetal-type thermostat is placed instead of the temperature fuse 112. In the bimetal-type thermostat, when the temperature reaches to a specified temperature (operating temperature), operating metals, which are in contact with each other at first, are separated from each other by thermal expansion, so that the energization to the heater element 111 is cut off.

[Reference 1] JP-A-2002-295783

In the foregoing excessive temperature rise prevention mechanism, and in the structure using the temperature fuse 112, the temperature fuse 112 is thermally degraded during long time operation and can fuse at a temperature lower than the specified melting temperature, and there is a problem in long-term reliability. Besides, when the temperatures fuse 112 is once melted, it must be replaced, and there is also a problem of not being economical.

In the structure using the thermostat 121 or the thermocouple 131, although there is an advantage that it can be used repeatedly, a separate circuit to control the thermostat 121 or the sensor 131 is required, and the cost is increased in total.

In the excessive temperature rise prevention mechanism using a bimetal-type thermostat, since energization/cutoff is performed by using the thermal expansion of the operating metals, in the process where the energization is cut off and the temperature drops, the operating metals, which were separated from each other at the time of the excessive temperature rise, are thermally contracted at a certain temperature (resetting temperature) to come in contact with each other again, and the energization is resumed. In recent years, particularly in the manufacturing apparatus of a semiconductor element, an FPD or the like, in view of safety, there is adopted a system in which an operator or a manager can recognize that the excessive temperature rise occurs in the mantle heater 100. However, the resetting temperature of the conventional bimetal-type thermostat is a temperature lower than the operating temperature, at which the operating metals start to be separated, by at most 10 to 30° C. Thus, there is a possibility that early restoring occurs automatically, the mantle heater 100 is restarted, and it can not be recognized that the excessive temperature rise occurs.

### SUMMARY OF THE INVENTION

The present invention has been made in view of such circumstances, and has an object to provide a heating apparatus in which an excessive temperature rise is appropriately detected and it can be certainly recognized that the excessive temperature occurs.

The present inventors have made eager investigation to examine the problem. As a result, it has been found that the foregoing objects can be achieved by the following heating apparatus. With this finding, the present invention is accomplished.

The present invention is mainly directed to the following items:

1. A heating apparatus comprising: a power source for heating; a heating element; and a bimetal-type thermostat placed between the power source and the heating element, the bimetal-type thermostat cutting off energization upon temperature reaching to a first temperature and restoring the energization upon temperature dropping and reaching to a second temperature, the bimetal-type thermostat having a resetting temperature of 0° C. or lower.

2. The heating apparatus according to item 1, wherein the resetting temperature of the bimetal-type thermostat is −35° C. or lower.

In the bimetal-type thermostat incorporated in the heating apparatus of the invention, the resetting temperature is 0° C. or lower and is remarkably low as compared with the conventional bimetal-type thermostat. Thus, when the heating apparatus causes an excessive temperature rise, the cutoff state continues in a general use environment (temperature is generally room temperature: approximately 20 to 25° C.), and the occurrence of the excessive temperature rise can be certainly recognized. In order to make such a function more certain, it is preferable that the resetting temperature of the bimetal-type thermostat is made −35° C. or lower. Furthermore, it is preferable that the resetting temperature of the bimetal-type thermostat is −196° C. or more.

### BRIEF DESCRIPTION OF THE DRAWINGS

FIG. 1 is a main part sectional view showing an embodiment of a heating apparatus of the invention.

FIG. 2 is a circuit diagram showing an excessive temperature rise prevention mechanism of the heating apparatus of FIG. 1.

FIG. 3 is a perspective view showing an example of a mantle heater.

FIG. 4 is a circuit diagram showing an example (temperature fuse is used) of a conventional excessive temperature rise prevention mechanism.

FIG. 5 is a circuit diagram showing another example (thermostat is used) of a conventional excessive temperature rise prevention mechanism.

FIG. 6 is a circuit diagram showing still another example (thermocouple is used) of a conventional excessive temperature rise prevention mechanism.

The reference numerals used in the drawings denote the followings, respectively.

10 heating apparatus

11 outer layer material

20 heater element

21 heater wire

22 inorganic fiber sheet

23 non-combustible fire-resistant fiber sheet

30 excessive temperature rise prevention mechanism

31 power source

32 bimetal-type thermostat

### DESCRIPTION OF EXEMPLARY EMBODIMENTS

In the present invention, a heating apparatus comprises a power source for heating, a heating element, and a bimetal-type thermostat. The bimetal-type thermostat is placed between the power source and the heating element. The bimetal-type thermostat cuts off energization when temperature reaches to a first temperature and restores the energization when temperature drops and reaches to a second temperature. The bimetal-type thermostat of the invention has a resetting temperature of 0° C. Furthermore, as described above, the resetting temperature of the bimetal-type thermostat is preferably −35° C. or lower.

Hereinafter, the invention will be described in detail with reference to the drawings.

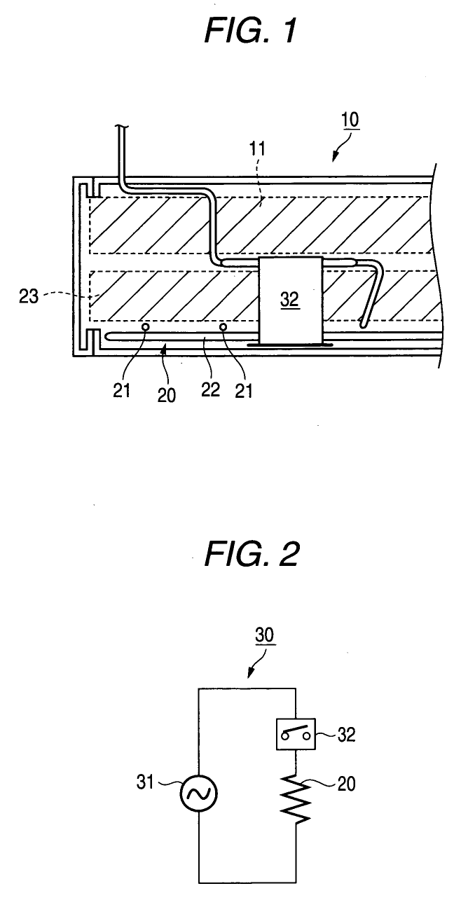

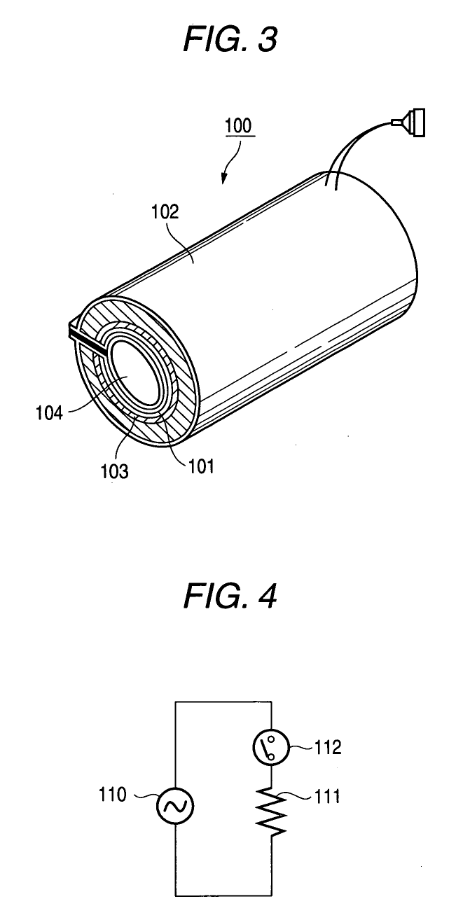

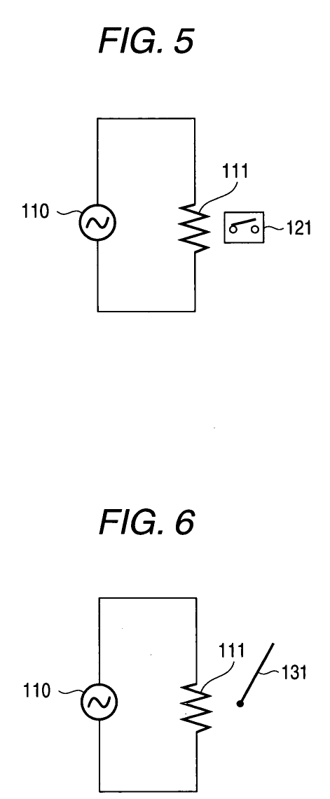

FIG. 1 is a main part sectional view showing an embodiment of a heating apparatus of the invention, and FIG. 2 is a circuit diagram showing an excessive temperature rise prevention mechanism. Incidentally, in the invention, the kind of the heating apparatus is not limited, and the invention can be applied to, for example, the mantle heater shown in FIG. 3.

As shown in the drawings, in a heating apparatus 10 of this embodiment, a heater element 20 and a bimetal-type thermostat 32 constituting an excessive temperature rise prevention mechanism 30 are connected in series to each other and are housed inside a thermal insulating layer 11.

As a material forming the thermal insulating layer 11, a fluorocarbon resin is preferably used. Specifically, PTFE (polytetrafluoroethylene), PFT (tetrafluoroethylene-perfluoroalkoxyethylene copolymer), FEP (tetrafluoroethylene-hexafluoropropylene copolymer) or the like is preferable. Besides, PCTFE (polychlorotrifluoroethylene), ETFE (tetrafluoroethylene-ethylene copolymer), ECTFE (chlorotrifluoroethylene-ethylene copolymer), PVDF (polyvinylidene fluoride) or the like can also be used.

As the heater element 20, one obtained by fixing a heater wire 21 of Ni—Cr or the like, which is insulation coated with a heat insulation cloth, to a glass cloth of an inorganic fiber sheet 22 can be used. This heater element 20 is attached to a non-combustible fire-resistant fiber sheet 23. As the non-combustible fire-resistant fiber sheet 23, an inorganic fiber sheet or an organic fiber sheet can be used. As the inorganic fiber sheet, it is preferable to use one obtained by applying needling to an inorganic fiber material such as glass fiber, ceramic fiber, or silica fiber. As the organic fiber sheet, sheets made of aramid, polyamid, polyimide and the like are enumerated.

The structure of the heating part of the heating apparatus 10 is roughly as described above, and in the invention, an excessive temperature rise prevention mechanism 30 as shown in FIG. 2 is provided. The excessive temperature rise prevention mechanism 30 is such that instead of the temperature fuse 112 shown in FIG. 4, a bimetal-type thermostat 32 is placed between a power source 31 and a heater element 20. The heater element 20 heats the heater wire 21 by electric power from the power source 31. When an excessive temperature rise occurs, operating metals of the bimetal-type thermostat 32 are separated from each other, and the energization is cut off.

In the invention, as the bimetal-type thermostat 32, one having a resetting temperature of 0° C. or lower is used. For example, since the use environment of a manufacturing apparatus of a semiconductor element or an FPD is approximately 20 to 25° C., when the resetting temperature is 0° C. or lower, the operating metals separated by the excessive temperature rise are not automatically returned to the contact state again. Thus, as compared with the case where the bimetal-type thermostat having the resetting temperature lower than the operating temperature by 10 to 30° C. as in the related art, the reliability is greatly improved. In order to make the function as stated above more certain, it is preferable to use the bimetal-type thermostat 32 having a resetting temperature of −35° C. or lower.

The operating temperature of the bimetal-type thermostat 32 is suitably set according to the usage or heating place, and for example, in the manufacturing apparatus of a semiconductor element or an FPD, it is generally set to about 250° C.

As the bimetal-type thermostat 32 having the resetting temperature of 0° C. or lower as stated above, one generally available in the market may be used.

In order to restore the bimetal-type thermostat 32, that is, in order to realize the resetting temperature, liquid nitrogen is dropped onto a portion where the bimetal-type thermostat 32 of the heating apparatus 20 is disposed, or dry ice is pressed thereto and cooling is performed.

The operation of the heating apparatus 10 of the invention is the same as the conventional heating apparatus, electric power is applied to the heater element 20, and when an excessive temperature rise occurs, the bimetal-type thermostat 32 operates to cut off the energization. By this, the heat generation of the heater element 20 is stopped, the temperature of the heating apparatus 10 continues to drop, and keeps, for example, room temperature. Since the bimetal-type thermostat 32 is not restored at the room temperature, in order to restart the heating apparatus 10, the operator or the manager must use liquid nitrogen or dry ice to restore the bimetal-type thermostat 32. Thus, the operator or the manager can certainly recognize the occurrence of the excessive temperature rise of the heating apparatus 10.

As described above, according to the heating apparatus of the invention, the excessive temperature rise is appropriately detected, and the occurrence of the excessive temperature rise can be certainly recognized.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2005-102741 filed on Mar. 31, 2005, and the contents thereof are incorporated herein by reference.

What is claimed is:

1. A heating apparatus comprising:
a power source for heating;
a heating element; and
a bimetal-type thermostat placed between the power source and the heating element,
the bimetal-type thermostat cutting off energization upon temperature reaching to a first temperature and restoring the energization upon temperature dropping and reaching to a second temperature, the bimetal-type thermostat having a resetting temperature of 0° C. or lower.

2. The heating apparatus according to claim 1,
wherein the resetting temperature of the bimetal-type thermostat is −35° C. or lower.
